(19) United States
(12) Patent Application Publication
(10) Pub. No.: US 2016/0112364 A1
(43) Pub. Date: Apr. 21, 2016

(54) Systems and Methods for Mobile Matchmaking Requiring Users to Chat before Successively Revealing Identities

(71) Applicant: Dwindle Dating, Inc., Santa Monica, CA (US)

(72) Inventors: Jacob Gelyana, Santa Monica, CA (US); Jorden Fox, Santa Monica, CA (US)

(73) Assignee: Dwindle Dating, Inc.

(21) Appl. No.: 14/886,886

(22) Filed: Oct. 19, 2015

Related U.S. Application Data
(60) Provisional application No. 62/065,257, filed on Oct. 17, 2014.

(51) Int. Cl. H04L 12/58; H04L 29/08

(52) U.S. Cl. CPC H04L 51/32; H04L 51/10; H04L 67/306

(57) ABSTRACT

A mobile matchmaking system including a chat server; and a user device including a network interface, a user interface, and a controller configured to: request, from the chat server, a match between the user and a matched user; initiate a first round of a chat mode including the steps of: initiating a chat conversation between the user and the matched user; receiving, from the chat server, access to a set of pictures, wherein the set of pictures includes a picture of the matched user and one or more decoy pictures; displaying, via the user interface, the set of pictures; and upon reaching an endpoint of the round, removing at least one of the one or more decoy pictures from the set of pictures; initiate further rounds of the chat mode until only pictures of the matched user remains in the set of pictures; and identifying the matched user.

### CROSS-REFERENCE TO RELATED APPLICATIONS

This application incorporates by reference and claims the benefit of priority to U.S. Provisional Patent Application No. 62/065,257 filed Oct. 17, 2014.

### BACKGROUND OF THE INVENTION

The present subject matter relates generally to systems and method for matchmaking on a mobile device. More specifically, the present invention relates to systems and methods for mobile matchmaking that permit users to chat without revealing each users' photo identity.

Meeting other people using mobile device applications is an increasingly popular form of online dating. Traditional online dating was built around a user striking up conversations with another user after viewing that user's profile. This form of online dating requires users to invest time in constructing a profile, and viewing other profiles. Additionally, the open messaging lead to a deluge of messages, creating a situation where a user is often writing many messages that might not even be read and receiving messages from people the user is not interested in. Accordingly, traditional online dating is often considered a lot of work that isn't fun and doesn't provide users with an experience as enjoyable as real-world dating.

More recently, matchmaking mobile dating applications, such as Tinder, have focused on matching users based solely upon liking the other user's picture. Matchmaking applications of this type eliminate the effort required to build a profile, read other people's profiles, and the deluge of messages from other users. However, many potential users are turned off by the superficiality of matchmaking using only pictures. Indeed, some users would prefer a matchmaking mobile dating application that permits users to get to know one another before determining their interest in the other user is based solely on looks.

Accordingly, there is a need for a mystery chat matchmaking mobile application, as described herein.

### BRIEF SUMMARY OF THE INVENTION

To meet the needs described above and others, the present disclosure provides systems and methods for mobile matchmaking (herein, ‘the matchmaking chat system’). The matchmaking chat system may include a matchmaking mobile application run on user devices that may require matched users to chat for a predetermined period of time, such as an hour, before their identities are revealed to each other. In other embodiments, users may be required to have a conversation of a minimum length before identities are revealed.

In an embodiment, the matchmaking chat system may have game-like functionality to permit a user to chat with another unknown user (the ‘matched user’). The game may include multiple rounds of chatting during which a picture of the matched user may be displayed along with a number of pictures from other decoy users as a set of mystery users. In this way, the user is unaware of which picture in the group of mystery users corresponds to the matched user with whom the user is chatting.

A user may begin chatting with the matched user using the mystery chat application by installing the matchmaking mobile application on the user's mobile device and logging in using a social network login, such as through the user's Facebook account. The user may indicate demographic information of other users that the user would prefer to be matched with, such as gender, age range, and location. For example, a user may indicate that he is interested in women between twenty-one and twenty-eight years old that currently are within fifteen miles of his current location. The user may then upload a number of pictures for use during the mystery chat. In an embodiment, a minimum of five pictures may be required.

Once the user has completed preliminary steps, the user may be matched with another user of the system as the matched user. Once matched with the matched user, a chat screen for chatting with the matched user is displayed. Information about the matched user may be limited, for example, the user may be provided with only the matched user's first name. Additionally, a photo of the matched user along with pictures of four other random decoy users may be displayed in a set of pictures in the form of a photo bar on the chat screen. In this way, the mystery regarding which of the five pictures is the current matched user may drive the user's interest in the conversation.

To promote chatting, a random question button may be provided to suggest potential questions or topics. In some embodiments, a user may be permitted to input information about him or herself, such as hobbies, interests, and passions, etc. The application may use information inputted about a chat partner to generate suggested questions. For example, if a user has indicated that she is a fan of the Chicago Bears, the random question button may suggest the user to ask “Do you follow any sports?” Further, in some embodiments, a user may add media to a chat conversation, such as images or video. In other embodiments, media may be forbidden to prevent a user from adding his or her image to the chat.

A “SKIP” button may provided so that at any time the user may click the “SKIP” button to end the conversation with the matched user and match with another user. The user may be asked to confirm the skip before the skip is made, and may be reminded that the skip is permanent and that the user will not have the option of restarting the conversation. In some embodiments, the number of skips that may be made in a given time period may be restricted to prevent the user from making skips based on the group of pictures provided. For example, a user may be permitted to skip five times in an hour, twelve times a day, or thirty times a week, etc.

Alternatively, at any time, the matched user may decide to skip the user. The user may then be notified of the skip and be permitted to find another match.

The chat screen may include a countdown clock that counts down the time the users have been chatting. In an embodiment, the countdown clock is 15 minutes. The countdown is continuous from the start of the match and, in an embodiment, stops only after five minutes of silence, upon one of the users pausing the chat, or upon a skip by one of the players to leave the conversation. As shown, the user may pause the game at any time to stop the countdown. The chat partner may be notified of the paused game.

When the countdown clock reaches zero, the current round is over, and a picture of one of the decoy users is removed. The clock is then reset and a new round begins. The application user interface may notify the user that the round has ended and note the number of rounds remaining.

In another embodiment, instead of a timer, a round may end when the user and the matched user meet a minimum conversation length. For example, in an embodiment, the first round may end after a total of six messages are sent. In an embodiment, each of the user and the matched user must make at least two messages to prevent one user from sending off all six messages to end the round. Then, in an embodiment, the second and third rounds may require a total of eight additional messages (at least three from each party) to end the round. Finally, the final round may require a total of ten additional messages (at least four from each party). Thus, in an embodiment, a total of thirty-two messages are sent back and forth between the user and the matched user before true identities are revealed.

After each round, additional pictures of the matched user and the decoy users may be accessed by clicking the preview picture of that user in the decoy bar. Clicking a preview photo may open a screen for viewing the available pictures for each mystery user. For example, in the first round, there are five mystery users in the photo bar and only one photo is accessible, in the second round, there are four mystery users in the photo bar and two pictures for each mystery user is accessible, in the third round, there are three mystery users in the photo bar and three pictures for each mystery user, and in the fourth round, there are two mystery users in the photo bar and four mystery pictures for each user.

It is understood that the number of rounds may be varied. For example, the number of rounds may be as few as one, or may be a greater number such as two rounds, three rounds, four rounds, five rounds, etc. In principle, any number of rounds may be used. Likewise, it is understood that the number of decoy pictures may be varied in tandem with the number of rounds. Thus, a two round game may have one decoy photo in addition to the chat partner photo, a three round game may have two decoy pictures in addition to the chat partner photo, etc.

It is also contemplated that in some embodiments, multiple decoy pictures may be removed per round, for example, as a reward for achieving an objective. As a specific example, the system may reward the user for eliciting particular information from their chat partner. In an embodiment, a user may input particular information about himself, such as the name of his favorite movie or food. If during chat, the user includes the information in a chat response, the matched user may be rewarded with the removal of extra decoy pictures. In some embodiments, the reward may be a reduction in clock time to reduce the length of a round.

Upon completing the final round, the final decoy user is removed and the matched partner is revealed. The user interface may congratulate the user display the name, photo and additional information about the chat partner. The matched user may be added as a match in a matches tab and the user may freely chat with the match at any time.

The application may list the previous matches that the user has successfully chatted with to the completion of the game in a matches screen. The user may select the conversation at any time and continue the conversation at will. The application may permit full use of standard chat features such as adding images, video, etc. Additionally, when a user is matched, in some embodiments, the user may be permitted to share contact information with matches, such as a phone number.

In an embodiment, a mobile matchmaking system includes: a chat server; and a user device of a user in communication with the chat server, including a network interface, a user interface, a controller in communication with the user interface and the network interface, and a non-transitory memory including instructions, that when executed by the controller, cause the controller to: request, from the chat server, a match between the user and a matched user; initiate a first round of a chat mode, wherein a round of the chat mode includes the steps of: initiating a chat conversation between the user and the matched user, wherein, during the chat conversation, the chat server relays messages from the user device to a user device of the matched user and relays messages from the user device of the matched user to the user device; receiving, from the chat server, access to a set of pictures, wherein the set of pictures includes a picture of the matched user and one or more decoy pictures, wherein each decoy picture corresponds to one of a set of one or more decoy individuals; displaying, via the user interface, the set of pictures; and upon reaching an endpoint of the round, removing at least one of the one or more decoy pictures from the set of pictures; initiate further rounds of the chat mode until only pictures of the matched user remains in the set of pictures; and displaying a notification identifying the matched user.

In an embodiment, the set of pictures includes five pictures when received, wherein a number of rounds is four. In an embodiment, the endpoint of each round is determined by a timer.

In an embodiment, the controller is further configured to: in response to detecting a message communicated by the matched user matching a condition, removing time from the timer for a current round.

In an embodiment, the chat server includes a database of user profiles for the user and the matched user, wherein the user profiles include matched user information associated with the matched user, wherein the condition is the presence of an element of the matched user information in the message communicated by the matched user. In an embodiment, the endpoint is reached upon meeting a predetermined number of messages communicated between the user and the matched user during the round. In an embodiment, the predetermined number of messages is at least six with at least two messages communicated by each of the user and the matched user.

In an embodiment, the chat server includes a database of user profiles for the user and the matched user, wherein the user profiles include user information associated with the user and matched user information associated with the matched user, wherein the chat server is configured to: in response to receiving a message communicated by the user including information matching an element of the user information, updating a user information score; in response to receiving a message communicated by the matched user including information matching an element of the matched user information, updating a matched user information score; and when the user information score and the matched user information score meet predetermined score amounts, communicate a notification to the controller to end the round.

In an embodiment, the controller is further configured to: upon reaching the endpoint, removing all decoy pictures from the set of pictures corresponding to one individual of the set of one or more decoy individuals and updating the set of pictures to include an additional picture for each remaining individual of the set of one or more decoy individuals.

In an embodiment, the controller is further configured to: in response to detecting a message communicated by the matched user matching a condition, removing all decoy pictures from the set of pictures corresponding to two individuals of the set of one or more decoy individuals. In an embodiment, the chat server includes a database of user profiles for the user and the matched user, wherein the user profiles include matched user information associated with the matched user, wherein the condition is the presence of an element of the matched user information in the message communicated by the matched user. In an embodiment, each individual of the set of one or more decoy individuals is a user of the system. In an embodiment, the controller is further configured to: prompt the user to input one or more pictures of the user; and transmit to the chat server, via the network interface, the one or more pictures of the user.

An object of the invention is to provide an alternative to popular dating apps that are focused solely on looks and require one user to initiate the conversation.

Another object of the invention is to provide a fun, new way for singles to meet one another by chatting and genuinely connecting without any superficial hesitations.

An advantage of the invention is that it eliminates the superficial aspect of online dating by highlighting users true personalities rather than their profile pictures.

Another advantage of the invention is that it provides a fun way to meet other people in a manner that feels like a game.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a diagram illustrating an example of a matchmaking chat system.

FIG. 2 is a schematic diagram illustrating an example user device of the matchmaking chat system.

FIG. 3 illustrates an example chat screen of the matchmaking chat system to permit the user to chat with another matched user.

FIG. 4 illustrates an example skip screen of the matchmaking chat system to permit the user to skip the current matched user and be matched with another.

FIG. 5 illustrates an example skip notification screen of the matchmaking chat system that informs the user that the matched user has skipped him or her.

FIG. 6 illustrates an example pause screen of the matchmaking chat system to permit the user to pause the game at any time.

FIG. 7 illustrates an example end round screen of the matchmaking chat system that notifies the user that the round has ended.

FIG. 8 illustrates an example pictures screen of the matchmaking chat system to permit the user to view the pictures of a selected mystery user.

FIG. 9 illustrates an example reveal screen of the matchmaking chat system to congratulate the user and display the name, real photo or pictures, and other information of the matched user.

FIG. 10 illustrates an example matches screen that lists the matches that the user has successfully chatted with to the completion of the game.

FIG. 11 illustrates an example method that may be executed by the matchmaking chat system in accordance with the principles of the invention.

### DETAILED DESCRIPTION OF THE INVENTION

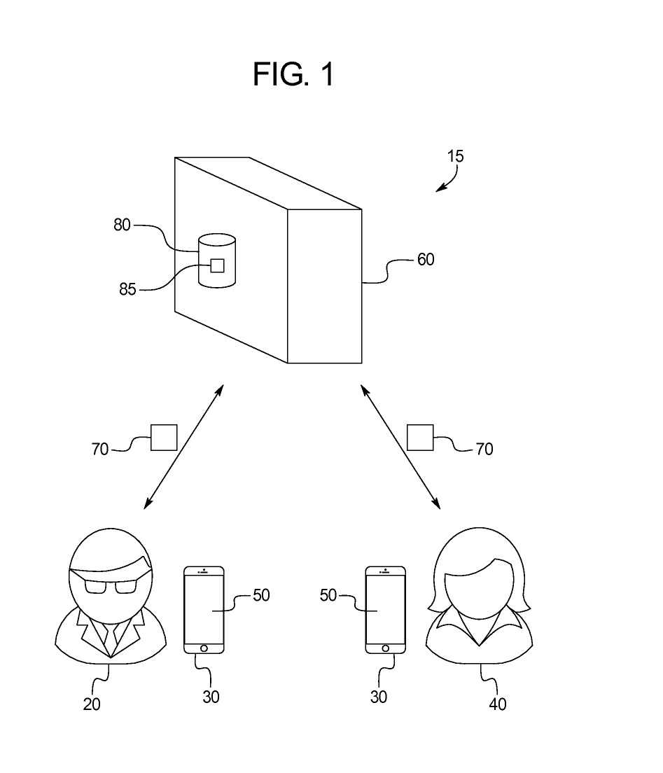

FIG. 1 illustrates an example of a matchmaking chat system 15. As shown in FIG. 1, the matchmaking chat system 15 permits a user 20 to chat with a matched user 40 whose identity is hidden. The user 20 chats with the matched user 40 using a matchmaking mobile application 50 running on a user device 30 that communicates with a user device 30 of the matched user 40 via a chat server 60. In an embodiment, the matchmaking mobile application 50 may require a user 20 to chat with a matched user 40 for a predetermined period of time, such as an hour, before their identities are revealed to each other.

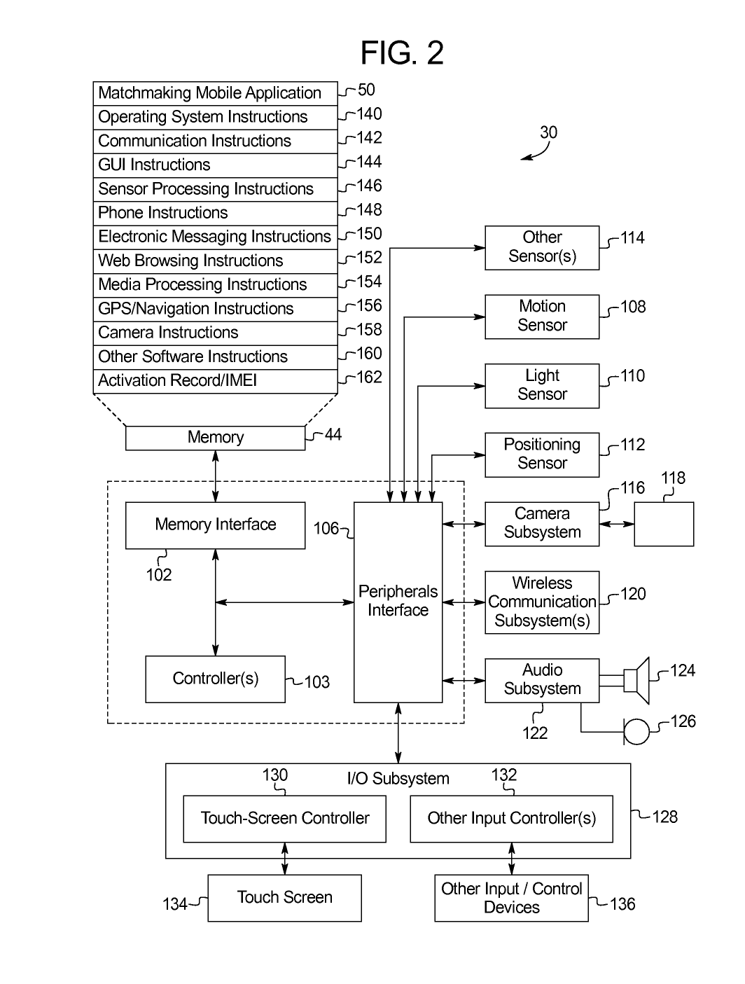

As shown in FIG. 2, the user device 30 may be a user device 30, such as a smartphone, running the matchmaking mobile application 50to provide the functionality described herein. The user device 30 may include wireless communication subsystem 120 to communicate with one or more chat servers 60. The chat server 60 may include a database of users to match for chat. In various embodiments, the chat server 60 and the user devices 30 coordinate to carry out the functionality of the chat system 15. Accordingly, it will be apparent to those of skill in the art from the disclosure herein that functionality described herein for the users devices 30 may, in some embodiments, be accomplished by the chat server 60, and conversely, the functionality described herein for the chat server 60 may, in some embodiments, be accomplished by the user devices 30.

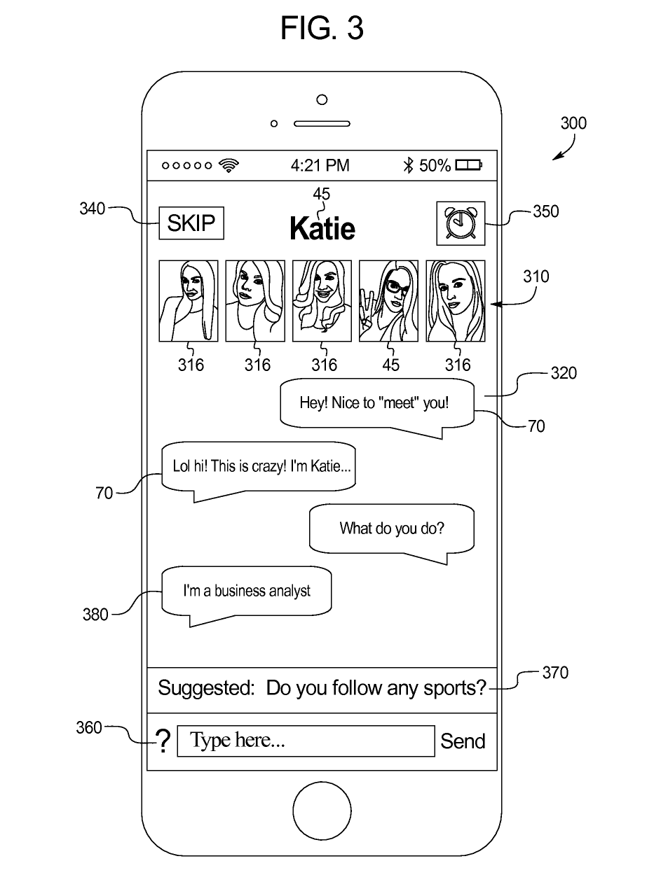

In an embodiment, the matchmaking mobile application 50 may have a game-like mystery chat functionality to permit a user 20 to chat with a matched user 40 unknown to the user 20. As shown in FIG. 3, a set of pictures 310 of various mystery users is displayed in a photo bar. The mystery users may include the matched user 40 and decoy pictures of a group of decoy users. A picture of each of the mystery users may be displayed. By providing a set of pictures 310 of mystery users, the user 20 is kept unaware of which picture in the set of pictures 310 corresponds to the matched user 40. The game may be the same for each player; so naturally, the matched user 40 will see on her mobile device 30 a picture of the user 20 along with a set of pictures 310 of various mystery users and will be unable to match the user 20 to his picture.

The game-like functionality may include multiple rounds. At the end of each round, one of the decoy users 316 may be removed from the set of pictures 310, and after the final round, details of the matched user 40, such as pictures of the matched user 40, may be revealed.

A user 20 may begin chatting with the matched user 40 using the mystery chat application by installing the application 50 on the user's mobile device 30 and logging in using a social network login, such as through the user's Facebook account. The user 20 may indicate demographic information of other users that the user 20 would prefer to be matched with, such as gender, age range, and location. For example, a user 20 may indicate that he is interested in women between twenty-one and twenty-eight years old that currently are within fifteen miles of his current location. The user 20 may then upload a number of pictures for use during the mystery chat conversation 320. In an embodiment, a minimum of five pictures may be required.

Once the user 20 has completed preliminary steps, the chat server 60 may match the user 20 with another user, the matched user 40. Once matched with the matched user 40, a chat screen 300 for chatting with the matched user 40 is displayed, as shown in FIG. 3. Information about the matched user 40 may be limited, for example, the user 20 may be provided with only the matched user's first name 45.

In an embodiment, when starting a game, the chat server 60 may search the database of other users who meet some or all of the user's preferences (gender, age, location) in order to begin a game. If another user matching the user's preferences is currently online and is also searching for a game and the user matches the other user's preferences, a game is started.

If no other user with mutual preferences is found, the chat servers 60 find ten registered users (who are not currently online) who match the user's preferences and send them each a push notification that a match is ready to start a game. The first of those ten users to click “Play” on the push notification may automatically be matched with the user 20 and game started. If after ninety seconds, none of the ten push notifications click “Play”, the user 20 is notified that there are no current matches and suggests that the user 20 try again. If the user 20 tries again, the chat servers 60 restart this process.

When a push notification is sent out, and more than one person selects “Play”, the first is entered into a game and the rest are treated as new users, prompting the chat servers 60 to restart the match finding process from the beginning for the rest of the users who selected “Play”.

Using this approach, two people with mutual match preferences do not need to be online looking to start a game at the exact same time. Push notifications for all registered users opens up the amount of matches for all users and allows for games to continuously be started. The user 20 may be permitted to select control settings on how/when push notifications will be sent to them when not playing the game.

To promote chatting a random question button 360 may be provided to suggest potential questions or topics. In some embodiments, users may be permitted to input into the system 15 personal information about him or her, such as hobbies, interests, and passions, etc. The matchmaking chat system 15 may use information inputted about a matched user 40 to generate suggested questions. For example, if a matched user 40 has indicated that she is a fan of the Chicago Bears, the random question button 360 may display a suggestion prompt 370 to suggest the user 20 ask, “Do you follow any sports?” Further, in some embodiments, a user 20 may add media to the chat conversation 320, such as images or video. In other embodiments, media may be forbidden to prevent a user 20 from adding his or her image to the chat conversation 320.

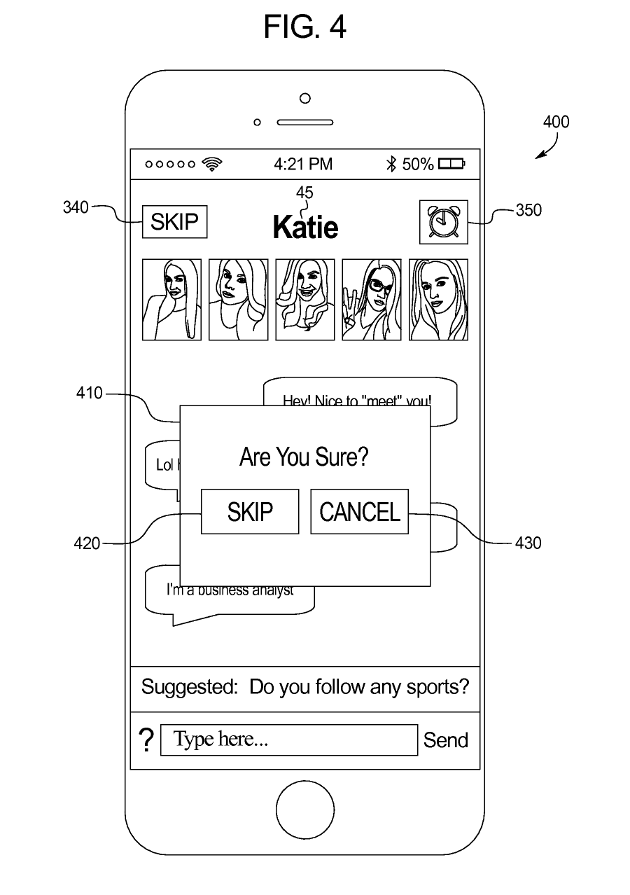

As shown in FIG. 4, a skip button 340 may provided so that at any time the user 20 may end the conversation with the matched user 40 and match with another user. The user 20 may click the skip button 340 to open a skip pop-up 410 of a skip screen 400. Using the skip pop-up 410, the user 20 may be asked to confirm the skip before the skip is made, and may be reminded that the skip is permanent and that the user 20 will not have the option of restarting the chat conversation 320. The user 20 may click the confirm skip button 420 or the cancel button 430, as desired. In some embodiments, the number of skips that may be made in a given time period may be restricted to prevent the user 20 from making skips based on the set of pictures 310 provided. For example, a user 20 may be permitted to skip up to five times in an hour, twelve times a day, or thirty times a week, etc.

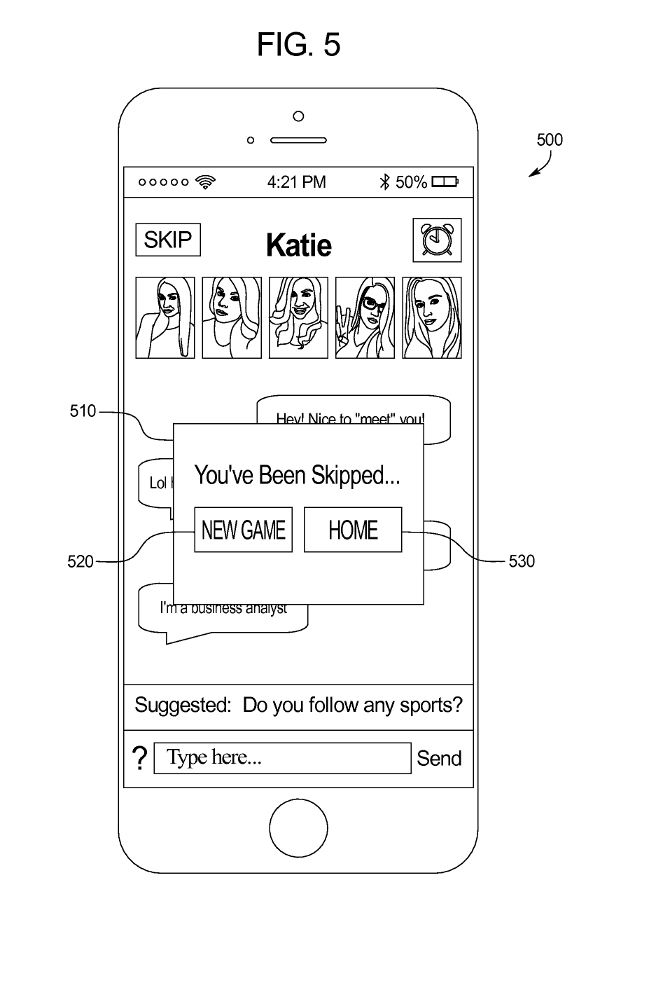

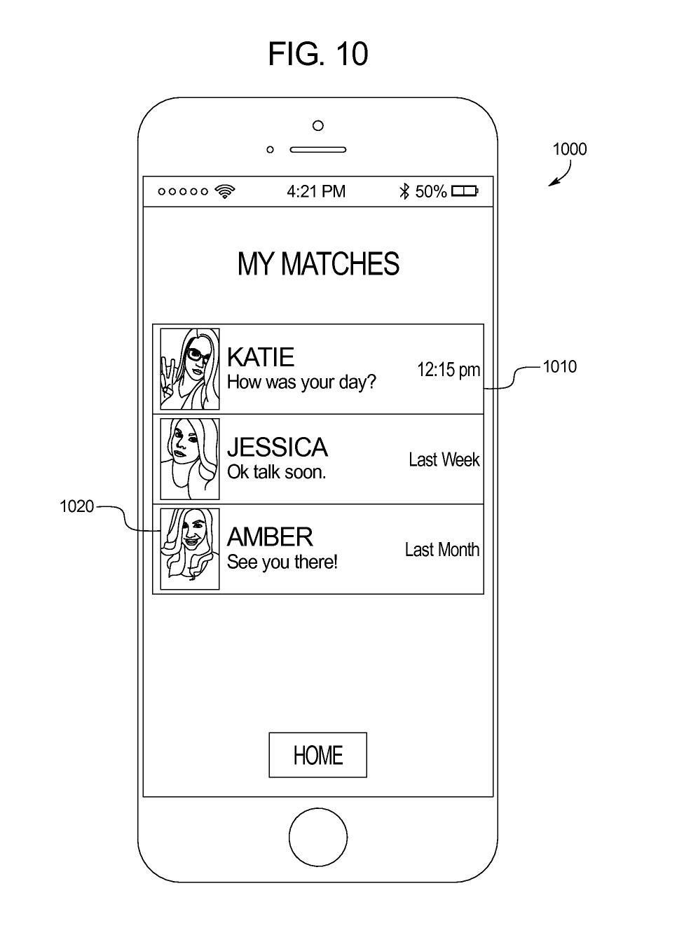

Alternatively, as shown in FIG. 5, at any time, the matched user 40 may decide to skip the user 20. The user 20 may then be notified of the skip and be permitted to match with another matched user 40. For example, as shown in a skip notification screen 500 of FIG. 5, a skip notification popup 510 has been displayed to inform the user 20 of the skip. The user 20 may select the home button 530 to return to the home screen and access the other functionality of the matchmaking mobile application 50, such as the matches screen 1000 of FIG. 10.

As shown in the FIG. 3, the chat screen 300 may include a timer 350. For example, in the embodiment shown, the timer 350 is a countdown clock that counts down the time the user 20 and the matched user 40 have been chatting. In an embodiment, the timer 350 may countdown a period of 15 minutes. The remaining time may be indicated by the position of the hands of the countdown clock of the timer 350. The countdown may operate continuously from the start of a round and may stop after five minutes of silence (no chatting), upon one of the user 20 or the matched user 40 pausing the chat, or upon a skip by one of the either the user 20 or the matched user 40 to end the conversation.

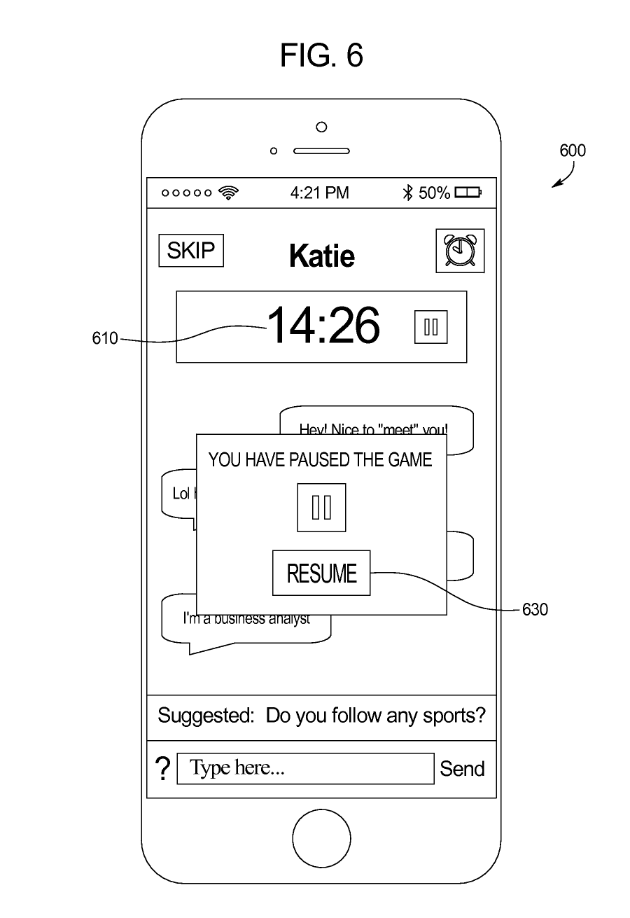

As shown in FIG. 6, the user 20 may pause the game at any time to stop the countdown. The matched user 40 may be notified of the paused game in a pause screen 600. The pause screen 600 may include the current remaining time 610. The user 20 may press the resume button 620 or send a message 70 to un-pause the game. The pause screen 600 may be initiated automatically at the end of a period of silence by both the user 20 and the matched user 40. For example, a pause may automatically trigger after one minute of silence.

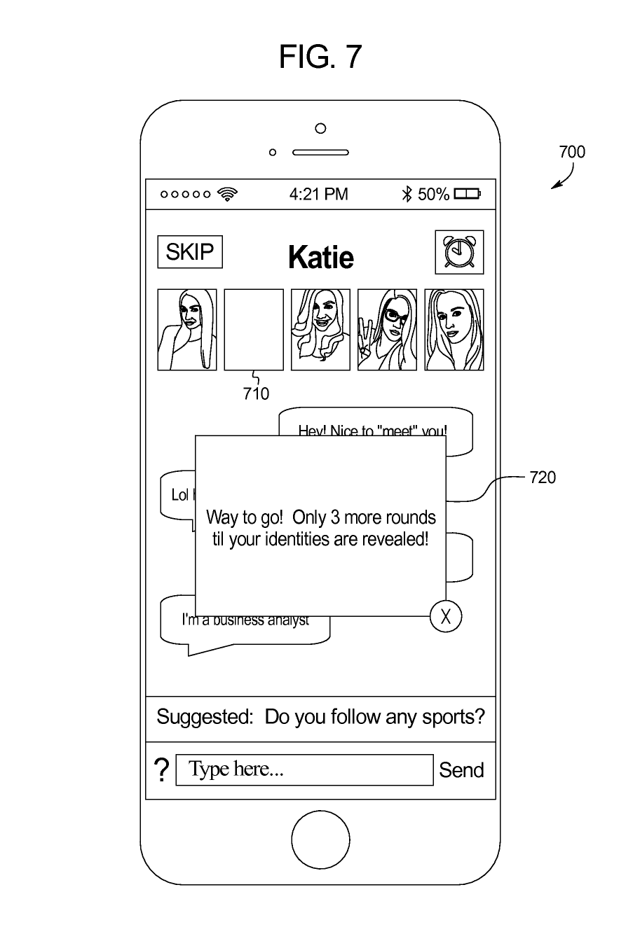

When the timer 350 reaches zero, the matchmaking chat system 15 may end the current round, and the pictures of one of the decoy users may be removed from the set of pictures 310. The timer 350 may then be reset and a new round started. As shown in FIG. 7, in an end round screen 700, the matchmaking mobile application 50 may notify the user 20 that the round has ended and that one of the decoy users has been eliminated. As shown, the eliminated decoy user 710 may be dimmed or removed completely from the set of pictures 310. Additionally, the user 20 may be congratulated and reminded of the number of rounds remaining in a notification box 720.

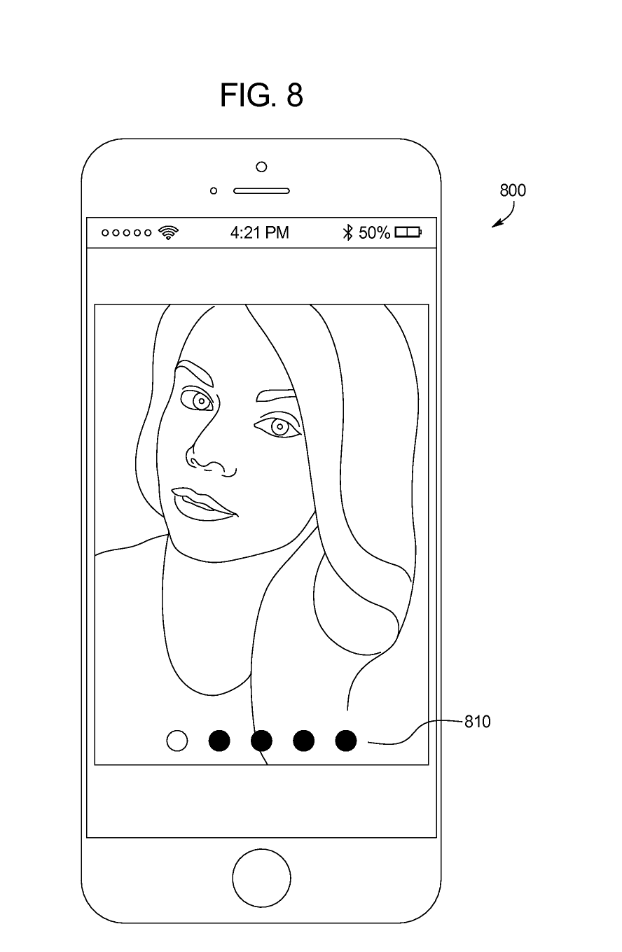

Turning to FIG. 8 the user 20 may click on any of the preview pictures of the set of pictures 310 in FIG. 3 to view pictures of the selected mystery user in the pictures screen 800. The user 20 may view the currently available pictures by swiping left or right to move through the list of pictures for that mystery user. A location indicator 810 may indicate the number of pictures available and the location of the current picture in the list of pictures being viewed. As described with respect to the rounds, the number of pictures available per mystery user may increase with every round.

In another embodiment, instead of a timer 350, a round may end when the user 20 and the matched user 40 meet a minimum conversation length. For example, in an embodiment, the first round may end after a total of six messages 70 are sent. In an embodiment, each of the user 20 and the matched user 40 must make at least two messages 70 to prevent either user from sending off all six messages to end the round. Then, in an embodiment, the second and third rounds may require a total of eight additional messages 70 (at least three from each party) to end the round. Finally, the final round may require a total of ten additional messages 70 (at least four from each party). Thus, in an embodiment, a total of thirty-two messages 70 are sent back and forth between the user 20 and the matched user 40 before true identities are revealed.

In a further embodiment, a round may end when the user 20 and the matched user 40 reveal a sufficient amount of personal information 380 about themselves. For example, a round may be ended after the user 20 reveals that his favorite food is pizza, he works in advertising, and wants to travel to Jamaica, and the matched user 40 reveals her favorite color is blue, she is a business analyst, and has recently traveled to Spain.

To determine whether a round is over, the system 15 may continuously monitor the messages 70 of the user 20 and the matched user 40 to determine if user profile information 85 has been revealed. User profile information 85 may include personal information 380 about the user 20 that is known to the system 15 and that counts towards a user information score that keeps track of amount of the user profile information 85 revealed by the user. A database 80 may store the user profile information 85 in user profiles for all users 20. The user profile information 85 may include a wide variety of user information collected from the user: such as demographic information, family information, personal history (schools attended, events attended, etc.), job history (occupation, current job, etc.), personal preferences (such as music preferences, food preferences, etc.), political preferences, etc. The matchmaking chat system 15 may present a questionnaire to a user 20 when the user 20 signs up with the system 15 to permit collection of the user profile information 85.

For an individual game, the system 15 may calculate a user information score for the user 20 and a matched user information score for the matched user 40. A round may end when the user information score and the matched user information score meet predetermined score amounts. For example, a round may end when both users reveal three pieces of personal information about themselves (in other embodiments, one, two, four, etc. pieces of personal information may be required). Alternatively, a round may end when both users in the chat reveal five pieces of personal information about themselves (in other embodiments, one, two, three, four, etc., pieces of personal information may be required).

After each round, additional pictures of each matched user 40 and decoy users may be accessed by clicking a preview photo of that user in the set of pictures 310. FIG. 8 illustrates a picture screen 800 for viewing the available pictures for a mystery user in the set of pictures 310. For example, in an embodiment, in the first round, there are five mystery users with one photo is accessible for each in the set of pictures 310, in the second round, there are four mystery users with two photo each in the set of pictures 310, in the third round, there are three mystery users in the set of pictures 310 and three pictures for each mystery user, and in the fourth round, there are two mystery users in the set of pictures 310 and four pictures for each mystery user. After the fourth round, the matched user 40 is revealed.

It is understood that the number of rounds may be varied. For example, the number of rounds may be as few as one (one matched user 40 and one decoy user 316), or may be a greater number such as two rounds, three rounds, four rounds, five rounds, etc. In principle, any number of rounds may be used. Likewise, it is understood that the number of decoy users 316 may be varied in tandem with the number of rounds. Thus, a two round game may have one decoy user 316 in addition to the matched user 40, a three round game may have two decoy users 316 in addition to the matched user 40, a four round game may have three decoy users 316 in addition to the matched user 40, etc.

It is also contemplated that in some embodiments, multiple decoy users 316 may be removed per round, for example, as a reward to achieving an objective. As a specific example, the application may reward the user 20 for eliciting particular information from the matched user 40. In an embodiment, a user 20 may ask the matched user 40 about personal information 380 about him or herself, such as the name of his or her favorite movie or food. If, during chat, the matched user 40 includes the personal information 380 in a chat message, the other user 20 may be rewarded with the removal of decoy users 316. In some embodiments, the reward may be a reduction in clock time to reduce the length of a round.

To determine whether a matched user 40 has revealed user profile information 85, the matchmaking chat system 15 may continuously scan the chat 70 of the matched user 40 to detect if messages 70 of the matched user 40 include an element of the user profile information 85. User profile information 85 may include personal information that a matched user 40 has included in his or her profile, information provided by the matched user 40 to the system 15, or information otherwise collected by the system 15.

In an embodiment, the matchmaking mobile application 50 may prompt the user 20 to try to collect the personal information 380. For example, the matchmaking mobile application 50 may prompt the user 20 “Find out [the matched user's] favorite food for a reward.” The prompt may be displayed in the suggestion prompt 370. If the matchmaking chat system 15 later detects that the matched user 20 has revealed his or her favorite food, the system 15 may reward the user 20.

It is contemplated that personal information may include any information about a matched user 40 that would be unknown to the user 20. For example, personal information 380 may include favorite foods, favorite restaurants, favorite bands, personal experiences, goals, educational background, job information, etc. In some embodiments, certain demographic information may be excluded from the personal information, such age, race, etc., that may reveal the identity of the matched user 40.

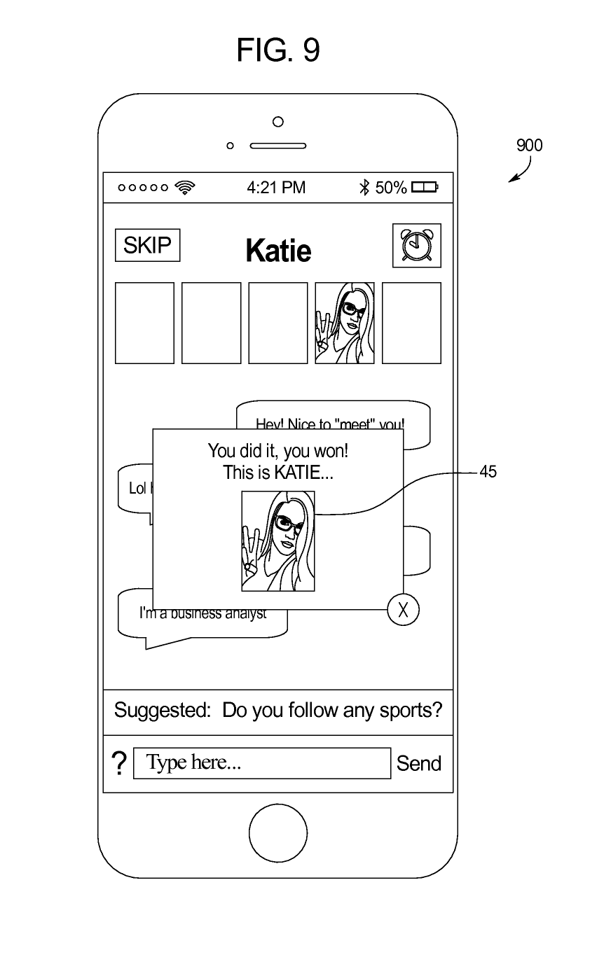

Upon completing the final round, the final decoy user 316 is removed and the matched user 40 is revealed. As shown in FIG. 9, a reveal screen 900 may congratulate the user 20 and display the name 910, real photo or pictures 920, and other information of the matched user 40. Additionally, the matched user 40 is added as a match 1010 in a matches screen 1000 of FIG. 10 and the user 20 may freely chat with the matched user 40 at any time.

As shown in FIG. 10, in a matches screen 1000, the matchmaking mobile application 50 may list the matches 1010 that the user 20 has successfully chatted with to the completion of the game. The user 20 may select the conversation 1020 for any of the matches 1010 at any time to continue chatting with that match 1010. When chatting with matches 1010, the matchmaking mobile application 50 may permit full use of standard chat features such as adding images, video, etc. Additionally, when a user 20 is matched, in some embodiments, the user 20 may be permitted to share contact information with the matched user 40, such as a phone number.

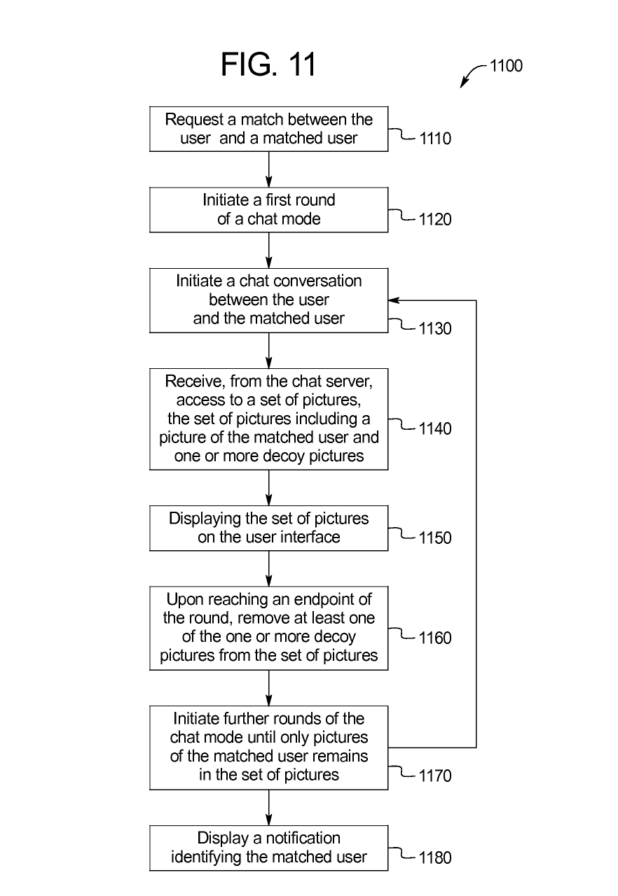

FIG. 11 illustrates an embodiment of a method 1100 executed by the user device 30 of the matchmaking chat system 15. First, at step 1110, the user device 30 requests from the chat server 60 a match between the user 20 and a matched user 40. Next, at step 1120, the user device 30 initiates a first round of a chat mode. A round of the chat mode includes the sub-steps 1130-1160. At sub-step 1130, the user device 30 initiates a chat conversation 320 between the user 20 and the matched user 40, wherein, during the chat conversation 320, the chat server 60 relays messages 70 from the user device 30 to a user device 30 of the matched user 40 and relays messages 70 from the user device 30 of the matched user 40 to the user device 30. At sub-step 1140, the user device 30 receives, from the chat server 60, access to a set of pictures 310, wherein the set of pictures 310 includes a picture of the matched user 40 and one or more decoy pictures, wherein each decoy picture corresponds to one of a set of one or more decoy individuals. At sub-step 1150, the user device 30 displays, via the user interface, the set of pictures 310. At sub-step 1160, the user device 30, upon reaching an endpoint of the round, removes at least one of the one or more decoy pictures from the set of pictures. At step 1170, the user device 30 initiates further rounds of the chat mode until only pictures of the matched user 40 remains in the set of pictures 310. Finally, at step 1180, the user device 30 displaying a notification identifying the matched user 40, as shown in FIG. 9.

The chat server 60 may include standard PC-type components, such as, a memory interface 102, controllers 103, such as one or more data processors, image processors and/or central processors, and a peripherals interface 106, etc. Both the chat server 60 and the user devices 30 may include network interfaces, such as communication subsystems 120, to permit them to communicate with each other.

Referring back to FIG. 2, the user device 30 may include a memory interface 102, controllers 103, such as one or more data processors, image processors and/or central processors, and a peripherals interface 106. The memory interface 102, the one or more controllers 103 and/or the peripherals interface 106 can be separate components or can be integrated in one or more integrated circuits. The various components in the user device 30 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 30 is intended to operate. For example, the user device 30 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the user device 30 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 44. The memory 44 can include high-speed random access memory and/or non-volatile memory, such as one or more magnetic disk storage devices, one or more optical storage devices, and/or flash memory (e.g., NAND, NOR). The memory 44 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 44 may also store communication instructions 142 to facilitate communicating with one or more additional devices, one or more computers and/or one or more servers. The memory 44 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 44 may also store other software instructions controlling other processes and functions of the user device 30 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 44.

Each of the above identified instructions and applications can correspond to a set of instructions for performing one or more functions described herein. These instructions need not be implemented as separate software programs, procedures, or modules. The memory 44 can include additional instructions or fewer instructions. Furthermore, various functions of the user device 30 may be implemented in hardware and/or in software, including in one or more signal processing and/or application specific integrated circuits. Accordingly, the user device 30, as shown in FIG. 2, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the user device 30. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as a PC-type implementation, those skilled in the art will recognize that the one or more controllers 103 also encompasses systems such as host computers, servers, workstations, network terminals, and the like. Further one or more controllers 103 may be embodied in a user device 30, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein and in the appendix will be apparent to those skilled in the art. Such changes and modifications may be made without departing from the spirit and scope of the present invention and without diminishing its attendant advantages.

1. A mobile matchmaking system comprising:
a chat server; and
a user device of a user in communication with the chat server, including
a network interface,
a user interface,
a controller in communication with the user interface and the network interface, and
a non-transitory memory including instructions, that when executed by the controller, cause the controller to:
request, from the chat server, a match between the user and a matched user;
initiate a first round of a chat mode, wherein a round of the chat mode includes the steps of:
initiating a chat conversation between the user and the matched user, wherein, during the chat conversation, the chat server relays messages from the user device to a user device of the matched user and relays messages from the user device of the matched user to the user device;
receiving, from the chat server, access to a set of pictures, wherein the set of pictures includes a picture of the matched user and one or more decoy pictures, wherein each decoy picture corresponds to one of a set of one or more decoy individuals;
displaying, via the user interface, the set of pictures; and
upon reaching an endpoint of the round, removing at least one of the one or more decoy pictures from the set of pictures;
initiate further rounds of the chat mode until only pictures of the matched user remains in the set of pictures; and
displaying a notification identifying the matched user.

2. The mobile matchmaking system of claim 1, wherein the set of pictures includes five pictures when received, wherein a number of rounds is four.

3. The mobile matchmaking system of claim 1, wherein the endpoint of each round is determined by a timer.

4. The mobile matchmaking system of claim 3, wherein the controller is further configured to:
in response to detecting a message communicated by the matched user matching a condition, removing time from the timer for a current round.

5. The mobile matchmaking system of claim 4, wherein the chat server includes a database of user profiles for the user and the matched user, wherein the user profiles include matched user information associated with the matched user, wherein the condition is the presence of an element of the matched user information in the message communicated by the matched user.

6. The mobile matchmaking system of claim 1, wherein the endpoint is reached upon meeting a predetermined number of messages communicated between the user and the matched user during the round.

7. The mobile matchmaking system of claim 6, wherein the predetermined number of messages is at least six with at least two messages communicated by each of the user and the matched user.

8. The mobile matchmaking system of claim 1, wherein the chat server includes a database of user profiles for the user and the matched user, wherein the user profiles include user information associated with the user and matched user information associated with the matched user, wherein the chat server is configured to:
in response to receiving a message communicated by the user including information matching an element of the user information, updating a user information score;
in response to receiving a message communicated by the matched user including information matching an element of the matched user information, updating a matched user information score; and
when the user information score and the matched user information score meet predetermined score amounts, communicate a notification to the controller to end the round.

9. The mobile matchmaking system of claim 1, wherein the controller is further configured to:
upon reaching the endpoint, removing all decoy pictures from the set of pictures corresponding to one individual of the set of one or more decoy individuals and updating the set of pictures to include an additional picture for each remaining individual of the set of one or more decoy individuals.

10. The mobile matchmaking system of claim 1, wherein the controller is further configured to:
in response to detecting a message communicated by the matched user matching a condition, removing all decoy pictures from the set of pictures corresponding to two individuals of the set of one or more decoy individuals.

11. The mobile matchmaking system of claim 10, wherein the chat server includes a database of user profiles for the user and the matched user, wherein the user profiles include matched user information associated with the matched user, wherein the condition is the presence of an element of the matched user information in the message communicated by the matched user.

12. The mobile matchmaking system of claim 1, wherein each individual of the set of one or more decoy individuals is a user of the system.

13. The mobile matchmaking system of claim 1, wherein the controller is further configured to:
prompt the user to input one or more pictures of the user; and
transmit to the chat server, via the network interface, the one or more pictures of the user.
